(19) United States
(12) Patent Application Publication
(10) Pub. No.: US 2008/0105149 A1
(43) Pub. Date: May 8, 2008

(54) Printing Plate Cylinder

(75) Inventors: Uwe Rogge, Lengerich (DE); Dietmar Koopmann, Lienen (DE); Manfred Loddenkoetter, Ibbenbueren (DE)

Correspondence Address: JACOBSON HOLMAN PLLC, 400 SEVENTH STREET N.W., SUITE 600, WASHINGTON, DC, 20004, US

(73) Assignee: WINDMOELLER & HOELSCHER KG, LENGERICH GERMANY (DE)

(21) Appl. No.: 11/665,861

(22) PCT Filed: Oct. 3, 2005
(86) PCT No.: PCT/EP05/10692

§ 371 Date: Apr. 20, 2007

(30) Foreign Application Priority Data
Oct. 20, 2004 (DE) 10-2004-051-041.5

(51) Int. Cl. B41F 13/08

(52) U.S. Cl. 101/375

(57) ABSTRACT

The invention describes a printing plate cylinder (1), which during the set up of the print machine is made up of at least the following elements (2,3):
A cylinder core (3) which is placed in the print machine as rotary and
a sleeve (2) which can be pulled over the cylinder core (3) at least partly.
In this angular position both of these elements (2,3) are alignable to each other through the following means:
A male register element (6,10,11) which is fixed on one of the two elements to be aligned,
a female register element (7) which is part of the corresponding other element to be aligned,

whereby both the register elements mentioned before stay in working connection with each other if the elements to be aligned (2, 3) are in the set position relative to each other.

At least one of the two register elements (6, 10, 11) is controlled by the other element (2, 3) to be aligned through movement.

The invention concerns a printing plate cylinder according to the preamble of claim 1.

In this print from printing plate cylinder those types of print cylinders are understood which carry a print impression. Printing plate cylinders are often made from different cylindrical shaped elements. As a rule a rotary base mandrel fixed at a machine frame forms the core of such a printing plate cylinder. It is clear that for changing tasks this mandrel is acted on by different print sleeves which carry different print impressions. For this purpose the printing sleeve is pulled over the base mandrel.

Besides these printing sleeves there are also known adapter sleeves which are also pulled over the base mandrel and fit the circumference of the thus formed cylinder core to the individually required print length. Often over this adapter sleeve either a further adapter cylinder or a print sleeve is slid anew. Such methods are for example known from Flexo Printing. In particular in Flexo Package Printing one has to do with a number of different print lengths which require many different adapters. The corresponding printing requirements are often satisfied with central cylinder flexo print machines. There are many adapter machines under these machines. The print-cases of these machines often carry a print-sleeve or a print-plate made from one of the flexible materials characteristic of flexo-print.

For all multi-color print processes the necessity to perform a register control or regulation is known to arise. For this purpose the position of the print impression in the different color works relative to each other has to be determined.

Therefore the position of the print impression relative to the base mandrel of the machine control or the machine operator must be known. For this the base mandrels of the print cylinder normally have register pins which protrude from the circumferential surface of the mandrel. The sleeves which cover the base mandrel have slots in which the pins either grip or snap if the sleeve reaches its set position relative to the mandrel. In this way the angular position of the sleeve to the mandrel is aligned and determined. If the sleeve is an adapter sleeve then at least a further sleeve—namely the print sleeve at least—must be brought to a fixed angular position on this sleeve and thus on the base mandrel. For this purpose the adapter sleeve has a register pin again which protrudes from its outer surface and grips a slot of the further sleeve for this purpose when it reaches its set position. This form of pre-registering is known for long and is well implemented even in the so called directly driven print machines in which each print plate cylinder has its own drive as well as in machines in which operational connections exist between different cylinders. Printing plate cylinders which are made from such base mandrels and sleeves and are aligned or registered in this way can be described in the following way:

Printing plate cylinder which at set up of the printing machine is made from at least the following cylindrical shaped elements:
A cylinder core which is placed in the print machine as rotary and
a sleeve which can be pulled over the cylinder core at least partly
whereby the angular position of both these elements to each other is settable as alignable through following means:
A male register element which is fixed on one of the two elements to be aligned,
a female register element which is part of the corresponding other element to be aligned,
whereby both the register elements previously mentioned stand in working connection with each other if the elements to be aligned are in the set position relative to each other.

Here it is to be observed that by cylinder core in the above sense is often understood to be the base mandrel. However in the sense of this print the concept cylinder core also includes a base mandrel which is acted upon with one or several sleeves. A male register element is often available as pin or some other protrusion which protrudes from the outer circumferential surface of the cylinder core or the inner circumferential surface of a further sleeve. A female register element is in the position to make a working connection—in first line a form of binding—with the male register element.

At set up or putting together of this printing plate cylinder according to current technology however there appear damages on register elements as well as on the sleeves also. This can be attributed to that the sleeves are not slid correct to the angle on the cylinder core so that the female register elements—in first line as slots—miss the register pins whereby at the end of the sliding movement it comes to collisions between the edges of the sleeves and the male register elements—up to now pins as a rule. Damages on the register elements as well as the edges of the wrapped sleeves are the result.

The task of the present invention is it to reduce these damages. This task is achieved through that

At least one of the two register elements is controlled by the other element to be aligned through movement.

Further implementation examples and details of the present invention follow in the detailed examples and corresponding description.

The individual figures show:

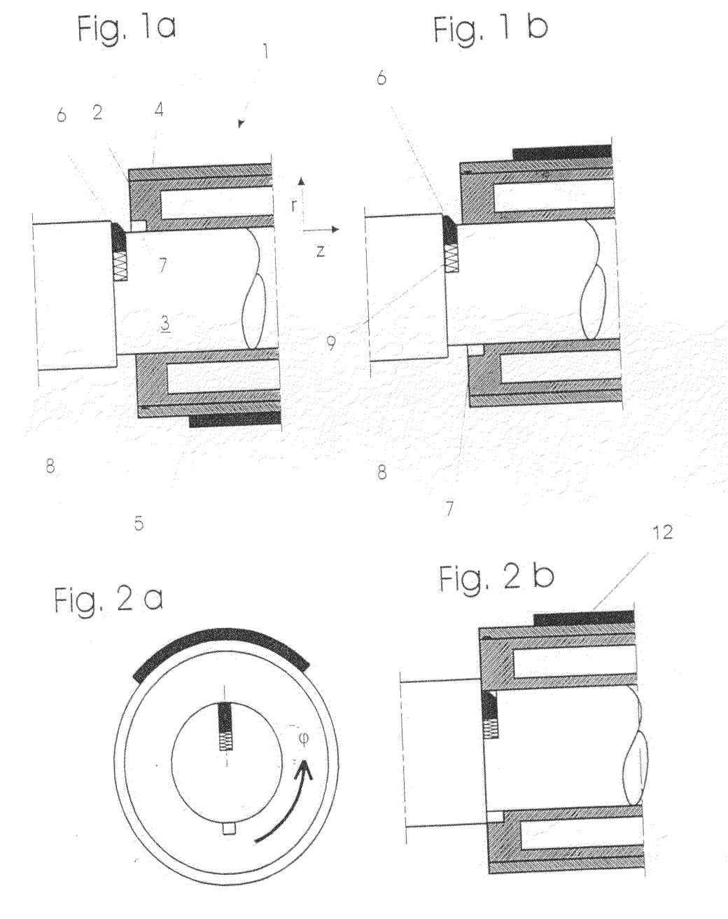

FIG. 1a A section A-A through a printing plate cylinder according to the invention during a phase of the set-up process

FIG. 1b A section A-A through the same printing plate cylinder according to the invention as in figure la during a phase of the set-up process

FIG. 2a A section A-A through the same printing plate cylinder according to the invention as in FIG. 1a during another phase of the set-up process

FIG. 2b A section B-B through the same printing plate cylinder according to the invention as in FIG. 1a during another phase of the set-up process

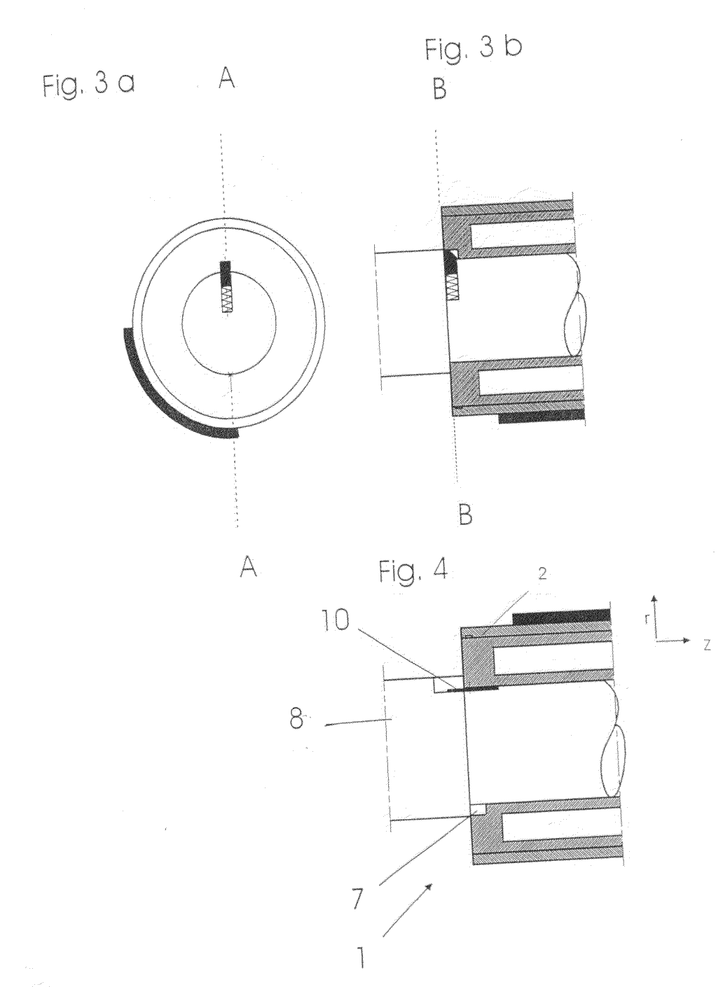

FIG. 3a A section A-A through the same printing plate cylinder according to the invention as in FIG. 1a at the end of the set-up process

FIG. 3b A section D-D through the same printing plate cylinder according to the invention as in FIG. 1a at the end of the set-up process

FIG. 4 A section in the axial-radial plane through another implementation example of a cylinder according to the invention

FIG. 5 A section in the axial-radial plane through the implementation example shown in FIG. 4 of a cylinder according to the invention

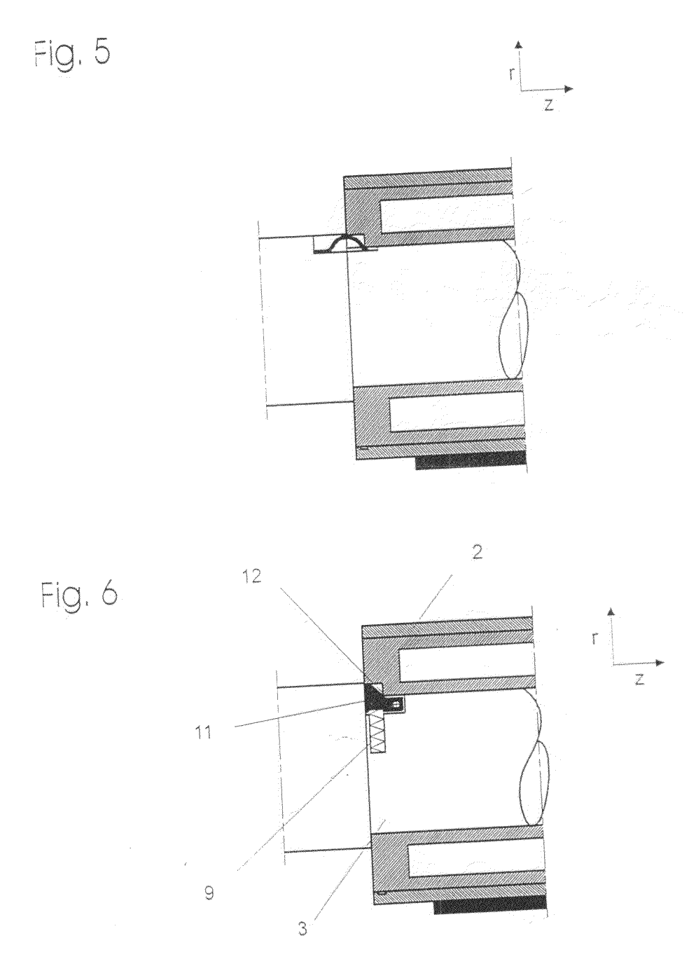

FIG. 6 A section in the axial-radial plane through another implementation example of a cylinder according to the invention

FIG. 1 shows a printing plate cylinder 1 which is just being set up. In this an adapter sleeve 2 in the axial direction z of the printing plate cylinder is being shifted on the cylinder mandrel 3. On the adapter sleeve 2 is the print sleeve 4, on which the printing plate 5 is placed. Here it is about a flexo-print cylinder.

In FIG. 1a it can be seen that the angular position between the male register element, here the pin 6, and the female register element, here the socket 7, is correctly set up. During further shifting of the adapter sleeve 2 on the cylinder core 3 the adapter sleeve 2 reaches the position which is shown in the FIGS. 3a and 3b. Here the male adapter element, the register pin 6, will grip the female register element, the socket 7, and thus fix the angular position of the cylinder core 3 to the adapter sleeve 2. During the further sliding in previous process, the adapter sleeve 2 will move against the block 8. In this way the axial movement of the sleeve 2 is ended.

The FIGS. 1b, 2a, 2b, 3a and 3b show the same implementation example of a printing plate cylinder according to the invention as the FIG. 1a. However in FIG. 1b the start position of the set up process is different from that in FIG. 1a. In FIG. 1b the angular position of the slot 7 against the register pin 6 is different. Because of reasons of display both these elements are shown angularly separate by 180°. However to each-specialist it is clear that in practice smaller angular deviations appear which however already lead to damages in printing plate cylinders according to the current state of technology. Despite the angular separation of the adapter sleeve 2 against the cylinder core 3 the adapter sleeve 2 moves against the block 8. Thus here the register pin 6 will be pressed under through the edge of the adapter sleeve 2. Thus the spring element 9 will become tense. The situation arising here is shown in the FIGS. 2a and 2b. The adapter sleeve 2 has reached the block 8, the male register element 6 is however pressed down, the female register element is still shifted about 180° against the male register element 6. Therefore the adapter sleeve 2 is slid in circumferential direction φ, until it reaches the situation shown in the FIGS. 3a and 3b. Here the adapter sleeve 7 is rotated so long until the slot 7 comes to the adapter pin 6, so that between both these elements a working connection can begin. In this case this will be caused by the spring 9 because this 9 presses the register pin 6 in the slot 7. Thus the set up process concerning the adapter sleeve and the cylinder core ends.

In FIG. 4 is shown another implementation example of a printing plate cylinder according to the invention. However here the male register element 10 is not in the form of a pin, but the complete male register element is a spring plate 10, which in FIG. 4 is being pressed on the surface through the edge of the adapter sleeve 2. It can also be recognized in FIG. 4 that this implementation example of a printing plate cylinder according to the invention has an adapter sleeve 2 with a slot 7. Also this slot 7 works as female register element.

In the situation shown in FIG. 4 the adapter sleeve has already reached its axial end position at the block 8. After that it will be rotated in its circumferential direction against the mandrel, until the slot 7 reaches the register element 10 and as shown in FIG. 5, pushes this out over the circumferential surface of the cylinder core through its spring force and in this way grips in the slot 7, whereby the angular position of the adapter sleeve 9 against the cylinder core 3 is fixed.

In FIG. 6 is shown another implementation example of a printing plate cylinder according to the invention whereby the adapter sleeve 2 and the cylinder core 3 of this printing plate cylinder have already reached their working position in their axial direction and in their angular position. The difference to the implementation examples shown before lies again in the furnishing of the male register element 11, which is fixed on the cylinder core 3 through the pin 12 (shown through a cross in the pin 11), which works as rotation axis of the pin 11. With this the register pin executes, if it is moved by the adapter sleeve, one of the pin 12 defined rotary movement in the radial and axial direction of the printing plate cylinder. It will still be revealed among others in the sub-claims that there are alternatives to the shown implementation examples and the described set up procedures. Thus for example register elements can be thought of which can only move in the axial direction. Furthermore it is conceivable to shape only the female register elements in some form when shifting. The blocks can be shown differently than in the present implementation examples. Thus for example, it is possible to include pins in the cylinder core which take over the function of the block. Here it is advantageous to make the blocking surface of this pin larger than the register pin used up to now to make the pressure effect, which appears by the collision of the adapter with these pins, smaller than the collision pressure which occurs up to now during collisions with the register pins. The setting of the angular position and the adapter sleeve to each other can naturally also be undertaken because the cylinder core is rotated against the adapter sleeve. This is possible without anything further because currently the cylinder core is furnished as rotary in rotation pressure machines. Also bringing the male register element on the adapter or a further sleeve as well as the female register element on the cylinder core is advantageous in certain use scenarios. Particularly limited are the displays of the invention undertaken in the present diagrams regarding the cylinder core and the adapter sleeve. Already in the introductory description it was mentioned that under the concept of cylinder core can even be understood a unit of base mandrel and an adapter sleeve. In this case the outer circumferential surface of the adapter sleeve is provided with a further register element. The next sleeve which is pulled on the adapter sleeve then has the counter piece to this register element and will be furnished according to the invention. Preferred application fields for the present invention are the flexo-print, here in particular the Flexo Package Print with central cylinder machines.

Reference Diagrams List

| | |
|---|---|
| 1 | Printing Plate Cylinder |
| 2 | Adapter Sleeve |
| 3 | Cylinderical Mandrel |
| 4 | Print Sleeve |
| 5 | |
| 6 | Register Pin |
| 7 | Slot |
| 8 | Block |
| 9 | Spring Element |
| 10 | Male Register Element/Spring Plate |
| 11 | Rotary Register Pin |
| 12 | Print Plate |
| z | Axial Direction of the Printing Plate Cylinder |
| φ | Circumferential Direction of the Printing Plate Cylinder |
| r | Radial Direction of the Printing Plate Cylinder |

1: Printing plate cylinder (1) which at set up of the print machine is made from at least following cylindrical shaped elements (2, 3):
A cylinder core (3) which is placed in the print machine as rotary and
a sleeve (2) which can be pulled over the cylinder core (3) at least partly
whereby the angular position of both these elements (2,3) to each other is alignable through the following means:
A male register element (6,10,11) which is fixed on one of the two elements (2,3) to be aligned,
a female register element (7) which is part of the corresponding other element to be aligned,
whereby both the register elements mentioned before stand in working connection with each other if the elements to be aligned (2,3) are in the set position relative to each other,
characterized in that
at least one of the two register elements (6, 10, 11) is controlled by the other element (2, 3) to be aligned through movement.

2: Printing plate cylinder (1) according to claim 1,
characterized in that
the movable register element (6, 10, 11) in the axial direction of the printing plate cylinder (z) is controlled when moving.

3: Printing plate cylinder (1) according to claim 1,
characterized in that
the moving register element (6, 10, 11) is controlled when moving in the peripheral direction (p) of the Printing Plate Cylinder (1).

4: Printing plate cylinder (1) according to claim 1,
characterized in that
the moving register element (6, 10, 11) can disappear in the circumferential surface of the printing plate cylinder (1).

5: Printing plate cylinder (1) according to claim 1,
characterized in that
the moving register element (6,10,11) which is the male register element, which (6,10,11) stays in working connection with a spring element (9), which (9) creates a feedback force, which moves the register element into the opening provided in the sleeve for the purpose, when this (sleeve) finds itself in its set position on the printing plate cylinder (1).

6: Printing plate cylinder (1) according to the previous claim,
characterized in that
the register element is a spring element (10).

7: Printing Plate Cylinder (1) according to claim 1,
characterized in that
the cylinder core (2) has a block (8).

8: Printing Plate Cylinder (1) according to claim 1,
characterized in that
the cylinder core (2) has a block (8) which shows a larger strike surface with the sleeve (3) than the male register element (6, 10, 11).

9: Printing plate cylinder according to the preceding claim,
characterized in that
the block (8) grips the circumference of the cylinder core (3).

10: Method for equipping a printing plate cylinder according to claim 1.
